(19) United States
(12) Patent Application Publication
(10) Pub. No.: US 2024/0204581 A1
(43) Pub. Date: Jun. 20, 2024

(54) WIRELESS POWER TRANSFER SYSTEM, POWER TRANSMISSION DEVICE OF WIRELESS POWER TRANSFER SYSTEM, AND POWER RECEPTION DEVICE OF WIRELESS POWER TRANSFER SYSTEM

(71) Applicant: Murata Manufacturing Co., Ltd., Kyoto-fu (JP)

(72) Inventors: Norikazu SAKAMOTO, Nagaokakyo-shi (JP); Tatsuya HOSOTANI, Nagaokakyo-shi (JP); Hiroto YASUI, Nagaokakyo-shi (JP)

(73) Assignee: Murata Manufacturing Co., Ltd., Kyoto-fu (JP)

(21) Appl. No.: 18/590,231

(22) Filed: Feb. 28, 2024

Related U.S. Application Data
(63) Continuation of application No. PCT/JP2022/031557, filed on Aug. 22, 2022.

(30) Foreign Application Priority Data
Aug. 30, 2021 (JP) 2021-139589

(51) Int. Cl. H02J 50/80; H02J 7/00; H02J 50/12

(52) U.S. Cl. CPC H02J 50/80; H02J 7/00045; H02J 50/12

(57) ABSTRACT

A wireless power transfer system includes a power transmission device and a power reception device. The power transmission device includes a power transmission circuit and a power transmission coil. The power reception device includes a power reception circuit and a power reception coil. The power reception device is arranged relative to the power transmission device such that the power reception coil electromagnetically couples with the power transmission coil. The power transmission circuit and the power reception circuit each set a power exclusive-use period and a signal insertion period. The power exclusive-use period is set as a main part of a repetition cycle of power transmission and reception, during which an interrupt signal for power transmission authentication is not used.

The signal insertion period is set as a localized part of the repetition cycle of power transmission and reception, during which the interrupt signal for power transmission authentication is inserted.

### CROSS-REFERENCE TO RELATED APPLICATIONS

This application claims benefit of priority to International Patent Application No. PCT/JP2022/031557, filed Aug. 22, 2022, and to Japanese Patent Application No. 2021-139589, filed Aug. 30, 2021, the entire contents of each are incorporated herein by reference.

### BACKGROUND

### Technical Field

The present disclosure relates to a wireless power transfer system that authenticates a power transmission device and/or a power reception device and further relates to a power transmission device and a power reception device to be used in this wireless power transfer system.

### Background Art

Japanese Patent No. 6278687 describes an electronic device that receives power wirelessly from a feed device. In the configuration described in Japanese Patent No. 6278687, the feed device transmits an authentication request command to the electronic device. In response to the authentication request command, the electronic device transmits an authentication reply signal to the feed device by using a modulation-and-demodulation circuit.

Also, a wireless power receiving device that receives power from a wireless power transmitting device and transmits received power to a load circuit. The wireless power receiving device sets a predetermined threshold value for rectified direct-current power and controls power transfer to the load circuit based on this threshold value.

### SUMMARY

However, in the configurations described in Japanese Patent No. 6278687, there is a possibility that when the power transmission device intentionally makes a deceptive response, for example, performs power transmission at a predetermined frequency, the power reception circuit may start working and provide erroneous power supply to the load circuit. Further, such erroneous power supply to the load circuit may cause unnecessary working of the load circuit and, for example, in the case where the load circuit makes a measurement or performs a predetermined process on a living subject, may lead to adverse effects on the living subject or unjustified acquisition of biological information.

Further, in the case where a coil being used for receiving power supply is also used for authentication, the efficiency of power reception may decrease in some cases.

Accordingly, the present disclosure provides a wireless power transfer system that realizes secure authentication and can suppress the decrease in power reception efficiency.

A wireless power transfer system of this disclosure includes a power transmission device and a power reception device. The power transmission device includes a power transmission circuit and a power transmission coil. The power transmission circuit generates, from a direct-current voltage, both alternating-current power for power transmission and a power transmission signal. The power transmission coil wirelessly transmits the alternating-current power and wirelessly transmits the power transmission signal. The power reception device includes a power reception coil and a power reception circuit. The power reception coil electromagnetically couples with the power transmission coil. The power reception circuit converts alternating-current power received with the power reception coil into a direct-current voltage by rectifying the alternating-current power.

The power transmission circuit includes a power transmission side control circuit that generates an interrupt signal for power transmission authentication and a power transmission side switching circuit that adjusts output of the power transmission signal to the power transmission coil by using the interrupt signal.

The power reception circuit includes a power reception side control circuit that determines, from the power transmission signal, the interrupt signal for power transmission authentication corresponding to the power transmission device, authenticates power transmission of the power transmission device by using the interrupt signal for power transmission authentication, and after performing the power transmission authentication, starts power supply to a load circuit or charging of a rechargeable battery.

The power transmission side control circuit and the power reception side control circuit each set a power exclusive-use period and a signal insertion period. The power exclusive use period is set as a main part of a power transmission-and-reception period during which the interrupt signal for power transmission authentication is not used. The signal insertion period is set as a localized part of the power transmission-and-reception period during which the interrupt signal for power transmission authentication is inserted.

With this configuration, in the period during which the power transmission is performed, the power exclusive-use period that is not used for authentication is set, and this power exclusive-use period is set considerably longer than the signal insertion period that is used for authentication. Further, in the authentication, it becomes possible to authenticate the power transmission device.

According to this disclosure, it becomes possible to provide a wireless power transfer system that realizes a secure authentication by authenticating power transmission of the power transmission device by using the interrupt signal for power transmission authentication and at the same time suppresses a decrease in power reception efficiency by setting the power exclusive-use period as a main part of the power transmission-and-reception period and the signal insertion period as a localized part of the power transmission-and-reception period during which the interrupt signal is inserted.

### BRIEF DESCRIPTION OF THE DRAWINGS

FIG. 1 is a functional block diagram illustrating a schematic configuration of a wireless power transfer system according to an embodiment of the present disclosure;

FIG. 2 is a functional block diagram of a power transmission device according to an embodiment of the present disclosure;

FIG. 3 is a functional block diagram of a power reception device according to an embodiment of the present disclosure;

FIG. 4 is a diagram illustrating examples of a device code to be used for authentication;

FIG. 5A is a diagram illustrating an example of transmitting power voltage transition when the device code is authenticated, FIG. 5B is a diagram that expands a signal insertion period in FIG. 5A, FIG. 5D is a diagram illustrating an example of received power voltage transition when the device code is authenticated, and FIG. 5C is a diagram that expands the signal insertion period in FIG. 5D;

FIG. 6A is a diagram that expands an interrupt signal period in FIG. 5B, and FIG. 6B is a diagram that expands an interrupt signal period in FIG. 5C;

FIG. 7 is a diagram that further expands a signal waveform of the interrupt signal period in FIG. 6A;

FIG. 8A is a diagram illustrating an example of the transmitting power voltage transition when the device code is not authenticated, FIG. 8B is a diagram that expands the signal insertion period in FIG. 8A, FIG. 8D is a diagram illustrating an example of the received power voltage transition when the device code is not authenticated, and FIG. 8C is a diagram that expands the signal insertion period in FIG. 8D;

FIG. 9A is a diagram that expands the interrupt signal period in FIG. 8B, and FIG. 9B is a diagram that expands the interrupt signal period in FIG. 8C;

FIG. 10 is a graph illustrating an example of a relationship between a length of power reception period and received power;

FIG. 11 includes flowcharts illustrating a first mode of authentication;

FIG. 12 is a flowchart of power transmission control for transmitting a power transmission device code illustrated in FIG. 11;

FIG. 13 is a flowchart of detection of the power transmission device code illustrated in FIG. 11;

FIG. 14 includes flowcharts illustrating a second mode of authentication;

FIG. 15 is a flowchart of processes in a power transmission device according to a third mode of authentication;

FIG. 16 is a flowchart of processes in a power reception device according to the third mode of authentication;

FIG. 17 is a flowchart of processes in a power transmission device according to a fourth mode of authentication;

FIG. 18 is a flowchart of processes in a power reception device according to the fourth mode of authentication;

FIG. 19 is a diagram illustrating examples of an operation code; and

FIG. 20 includes flowcharts for operation control.

### DETAILED DESCRIPTION

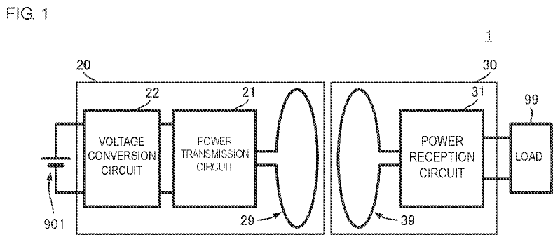

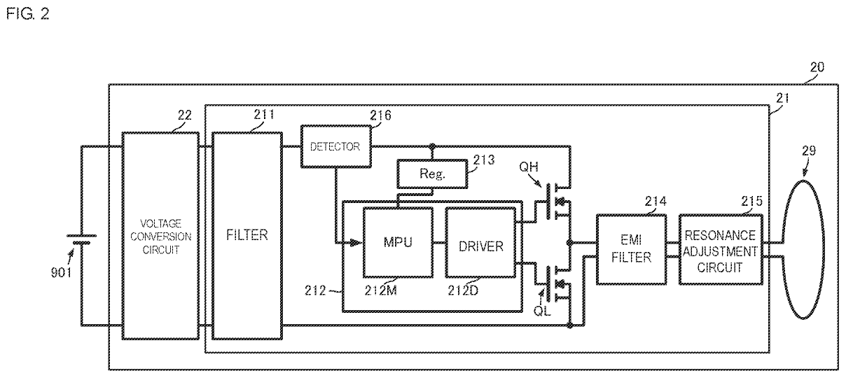

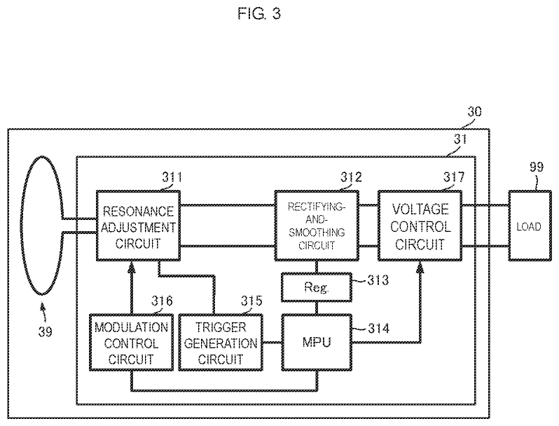

A wireless power transfer system according to an embodiment of the present disclosure is described with reference to the drawings. FIG. 1 is a functional block diagram illustrating a schematic configuration of the wireless power transfer system according to the embodiment of the present disclosure. FIG. 2 is a functional block diagram of a power transmission device according to the embodiment of the present disclosure. FIG. 3 is a functional block diagram of a power reception device according to the embodiment of the present disclosure.

### Configuration of Wireless Power Transfer System 1

As illustrated in FIG. 1, a wireless power transfer system 1 includes a power transmission device 20 and a power reception device 30. A direct-current power source 901 is connected to the power transmission device 20. A load circuit 99 is connected to the power reception device 30.

In the case where the power reception device 30 and the load circuit 99 are used for biological information sensing, the load circuit 99 is a sensing circuit, a wireless communication circuit, or the like. The sensing circuit performs sensing of a variety of biological information (temperature and the like) of a living subject. The wireless communication circuit performs communication regarding obtained biological information. Note that the load circuit 99 may be a rechargeable battery for charging.

### Configuration of Power Transmission Device 20

As illustrated in FIG. 1 and FIG. 2, the power transmission device 20 includes a power transmission circuit 21, a voltage conversion circuit 22, and a power transmission coil 29. The power transmission circuit 21 includes a filter 211, a power transmission side control circuit 212, a regulator 213, an EMI filter 214, a resonance adjustment circuit 215, a detector 216, a switching device QH, and a switching device QL. The power transmission side control circuit 212 includes a MPU 212M and a driver IC 212D.

Input terminals of the voltage conversion circuit 22 are connected to the direct-current power source 901. Output terminals of the voltage conversion circuit 22 are connected to input terminals of the filter 211.

A high potential side output terminal of the filter 211 is connected to a drain of the switching device QH. A low potential side output terminal of the filter 211 is connected to a source of the switching device QL.

A source of the switching device QH is connected to a drain of the switching device QL. These switching devices QH and QL make up a power transmission side switching circuit.

The MPU 212M is connected to the driver IC 212D. The driver IC 212D is connected to a gate of the switching device QH and a gate of the switching device QL.

The detector 216 is connected between the high potential side output terminal of the filter 211 and the drain of the switching device QH. The regulator 213 is connected to a high-potential-side line that connects the high potential side output terminal of the filter 211 and the drain of the switching device QH, and to the MPU 212M of the power transmission side control circuit 212.

Input terminals of the EMI filter 214 are connected to a node between the source of the switching device QH and the drain of the switching device QL and to the source of the switching device QL and the low potential side output terminal of the filter 211.

Output terminals of the EMI filter 214 are connected to input terminals of the resonance adjustment circuit 215. Output terminals of the resonance adjustment circuit 215 are connected to the power transmission coil 29.

### Basic Operation of Power Transmission Device 20 at Time of Power Transmission

The voltage conversion circuit 22 is a so-called DCDC converter and outputs a predetermined voltage to the filter 211 by voltage-converting a direct-current voltage from the direct-current power source 901 to the predetermined voltage. The filter 211 performs a filtering process (for example, a noise suppression process) on a direct-current voltage (direct-current current) from the voltage conversion circuit 22.

A direct-current voltage (direct-current current) after performing the filtering process in the filter 211 is supplied to a switching circuit made up of the switching device QH and the switching device QL.

Further, the direct-current voltage after performing the filtering process in the filter 211 is supplied to the regulator 213. The regulator 213 generates a power source voltage for the MPU 212M from the input direct-current voltage and supplies the generated power source voltage to the MPU 212M.

The MPU 212M generates a control signal for switching control of the switching device QH and the switching device QL. The control signal uses, as a base signal, a rectangular wave clock signal having a predetermined clock frequency (for example, 6.78 MHz or 13.56 MHz of ISM band) that defines a start and an end of power transmission. Further, although details will be described later, the control signal is a signal obtained by performing an interrupt process for power transmission authentication on that clock signal. Of the control signal, a signal in the period during which the interrupt process is performed corresponds to an “interrupt signal for power transmission authentication” of the present disclosure.

The MPU 212M outputs the control signal to the driver IC 212D.

Based on the control signal, the driver IC 212D generates a Hi-side switching control signal for the switching device QH and a Low-side switching control signal for the switching device QL. The Hi-side switching control signal and the Low-side switching control signal are signals whose voltages are inverted with respect to each other. That is to say, when the Hi-side switching control signal is at high potential, the Low-side switching control signal is at low potential, and when the Hi-side switching control signal is at low potential, the Low-side switching control signal is at high potential.

The driver IC 212D supplies the Hi-side switching control signal to the switching device QH and supplies the Low-side switching control signal to the switching device QL. At this time, the driver IC 212D synchronizes the Hi-side switching control signal and the Low-side switching control signal and supplies these synchronized signals to the switching device QH and the switching device QL.

On and off of the switching device QH are controlled based on the Hi-side switching control signal. On and off of the switching device QL are controlled based on the Low-side switching control signal.

Because of this, an alternating-current signal in which basically a high potential and a low potential are repeated alternately in response to the frequency of the clock signal is output from the switching circuit to the EMI filter 214. Note that although details will be described later, in this case, during the period of the interrupt process for power transmission authentication, this interrupt process causes a change in the waveform of the alternating-current signal.

This alternating-current signal undergoes a filtering process in the EMI filter 214 and is input to the resonance adjustment circuit 215.

The resonance adjustment circuit 215 includes at least one capacitor and makes up a power transmission resonant circuit with the power transmission coil 29. A resonant frequency of the power transmission resonant circuit is set equal to the frequency of the clock signal.

The power transmission coil 29 generates an alternating magnetic field based on the alternating-current signal.

### Configuration of Power Reception Device 30

As illustrated in FIG. 1 and FIG. 3, the power reception device 30 includes a power reception circuit 31 and a power reception coil 39. The power reception circuit 31 includes a resonance adjustment circuit 311, a rectifying-and-smoothing circuit 312, a regulator 313, a MPU 314, a trigger generation circuit 315, a modulation control circuit 316, and a voltage control circuit 317. The MPU 314, the trigger generation circuit 315, and the modulation control circuit 316 correspond to a “power reception side control circuit” of the present disclosure.

Input terminals of the resonance adjustment circuit 311 are connected to the power reception coil 39. Output terminals of the resonance adjustment circuit 311 are connected to input terminals of the rectifying-and-smoothing circuit 312. Output terminals of the rectifying-and-smoothing circuit 312 are connected to input terminals of the voltage control circuit 317. Output terminals of the voltage control circuit 317 are output terminals of the power reception device 30 and are connected to the load circuit 99.

The regulator 313 is connected to the rectifying-and-smoothing circuit 312 and is also connected to the MPU 314. The MPU 314 is connected to the modulation control circuit 316 and is also connected to the voltage control circuit 317.

### Basic Operation of Power Reception Device 30 at Time of Power Reception

The resonance adjustment circuit 311 includes at least one capacitor and makes up a power reception resonant circuit with the power reception coil 39. A resonant frequency of the power reception resonant circuit is set to the frequency of the alternating magnetic field, which is equal to the resonant frequency of the power transmission resonant circuit.

In the case where the power reception coil 39 and the power transmission coil 29 are arranged so as to couple electromagnetically with each other, the power reception coil 39 couples with the alternating magnetic field and generates an alternating-current current. At this time, as described above, the resonant frequency of the power reception resonant circuit is set equal to the resonant frequency of the power transmission resonant circuit, and this makes it possible to generate an alternating-current current from an alternating magnetic field with low loss.

The resonance adjustment circuit 311 outputs this alternating-current current to the rectifying-and-smoothing circuit 312.

The rectifying-and-smoothing circuit 312 is, for example, made up of a full-wave rectifying circuit that uses a rectifying element and a smoothing circuit that uses an inductor. The rectifying-and-smoothing circuit 312 converts an alternating-current current input from the resonance adjustment circuit 311 into a direct-current voltage. The rectifying-and-smoothing circuit 312 outputs the direct-current voltage to the voltage control circuit 317.

The voltage control circuit 317 is a so-called DCDC converter and converts the direct-current voltage input from the rectifying-and-smoothing circuit 312 into a direct-current output voltage that corresponds to the load circuit 99. The voltage control circuit 317 supplies the direct-current output voltage (direct-current output current) to the load circuit 99.

The direct-current voltage output from the rectifying-and-smoothing circuit 312 is supplied to the regulator 313. The regulator 313 generates a power source voltage for the MPU 314 from the input direct-current voltage and supplies the generated power source voltage to the MPU 314.

The MPU 314 performs a drive control of the voltage control circuit 317. For example, the MPU 314 measures an output voltage of the rectifying-and-smoothing circuit 312 and based on this measurement result, controls activation and termination of the voltage control circuit 317. Further, the MPU 314 controls activation and termination of the voltage control circuit 317 based on a power supply instruction from the power transmission device 20 to the load circuit 99, which will be described later.

### Schematic Description of Configuration and Operation Used for Authentication

### Authentication of Power Transmission Device 20 by Power Reception Device 30

The MPU 212M of the power transmission device 20 generates an interrupt signal (interrupt signal for power transmission authentication) that reflects a power transmission device code of the power transmission device 20 and supplies this interrupt signal to the driver IC 212D. The driver IC 212D controls on and off of the switching devices QH and QL based on the interrupt signal.

Because of this, a signal, which is obtained by shaping the waveform of the aforementioned alternating-current signal for power transmission by using the interrupt signal for power transmission authentication, is supplied to the power transmission coil 29.

Because the power transmission coil 29 and the power reception coil 39 are electromagnetically coupled with each other, the alternating-current current output from the resonance adjustment circuit 311 of the power reception device 30 has the same waveform as the alternating-current signal for power transmission, and the state of the waveform shaped by the interrupt signal for power transmission authentication is maintained. Because of this, the power transmission device code of the power transmission device 20 is transmitted from the power transmission device 20 to the power reception device 30 by using an alternating-current signal for power transmission and reception as the interrupt signal for power transmission authentication.

The trigger generation circuit 315 of the power reception device 30 is connected to the resonance adjustment circuit 311 and is realized, for example, by using a resistance voltage divider circuit. The trigger generation circuit 315 converts the alternating-current current flowing through the resonance adjustment circuit 311 into a voltage signal and outputs this voltage signal to the MPU 314 as an interrupt detection signal.

The MPU 314 determines an interrupt signal for power transmission authentication from the interrupt detection signal. The MPU 314 demodulates the power transmission device code from the interrupt signal for power transmission authentication and authenticates the power transmission device 20.

If the authentication is OK, the MPU 314 performs an activation start control of the voltage control circuit 317. For example, the MPU 314 outputs an enable signal to the voltage control circuit 317. This starts supply of power to the load circuit 99. If the authentication is NG, the MPU 314 does not perform the activation start control of the voltage control circuit 317 or performs an activation termination control of the voltage control circuit 317. For example, the MPU 314 terminates outputting of the enable signal to the voltage control circuit 317. This stops the supply of power to the load circuit 99.

As described above, in the wireless power transfer system 1, the power reception device 30 can authenticate the power transmission device 20. This enables the wireless power transfer system 1 to realize a secure system.

### Authentication of Power Reception Device 30 by Power Transmission Device 20

The MPU 314 generates a power reception device code and supplies this power reception device code to the modulation control circuit 316.

The modulation control circuit 316 adjusts the impedance of the resonance adjustment circuit 311 based on the power reception device code. A change in the impedance of the resonance adjustment circuit 311 changes the coupling state between the power reception coil 39 and the power transmission coil 29, and this changes a level of load modulation.

When the level of load modulation changes, the current value of a direct-current current that flows through the power transmission circuit 21 changes. Because of this, the power reception device code from the power reception device 30 is transmitted from the power reception device 30 to the power transmission device 20 by using the alternating-current signal for power transmission and reception.

The detector 216 voltage-converts this direct-current current, generates a power reception device code detection signal, and outputs this power reception device code detection signal to the MPU 212M.

The MPU 212M demodulates the power reception device code from the power reception device code detection signal and determines whether the authentication is OK or the authentication is NG.

If the authentication is OK, the MPU 212M performs a power transmission control (power transmission continuation control) of the switching circuit through the driver IC 212D. Because of this, power is continuously supplied from the power transmission device 20 to the power reception device 30. If the authentication is NG, the MPU 212M performs a power transmission termination control of the switching circuit through the driver IC 212D. Because of this, power is not supplied from the power transmission device 20 to the power reception device 30.

As described above, in the wireless power transfer system 1, the power transmission device 20 can authenticate the power reception device 30. This enables the wireless power transfer system 1 to realize a secure system.

Further, by authenticating the power transmission device 20 by the power reception device 30 and authenticating the power transmission device 30 by the power reception device 20, the wireless power transfer system 1 can realize a more secure system.

### More Specific Description Regarding Authentication of Power Transmission Device 20 by Power Reception Device 30

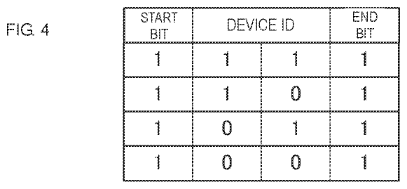

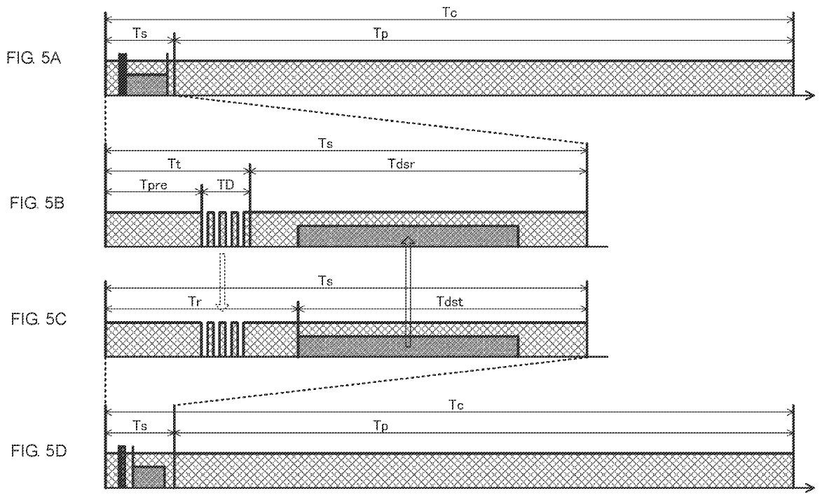

FIG. 4 is a diagram illustrating examples of the device code to be used for authentication. FIG. 5A is a diagram illustrating an example of transmitting power voltage transition when the device code is authenticated, and FIG. 5B is a diagram that expands a signal insertion period in FIG. 5A. FIG. 5D is a diagram illustrating an example of received power voltage transition when the device code is authenticated, and FIG. 5C is a diagram that expands a signal insertion period in FIG. 5D.

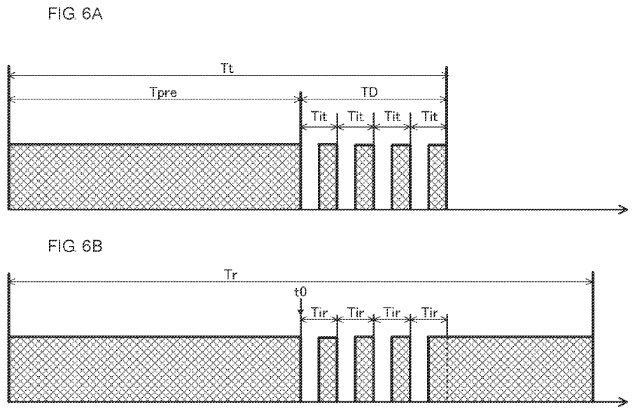

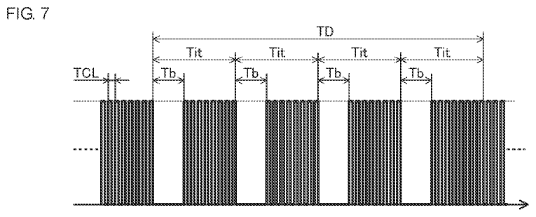

FIG. 6A is a diagram that expands an interrupt signal period in FIG. 5B, and FIG. 6B is a diagram that expands an interrupt signal period in FIG. 5C. FIG. 7 is a diagram that further expands a signal waveform in the interrupt signal period in FIG. 6A.

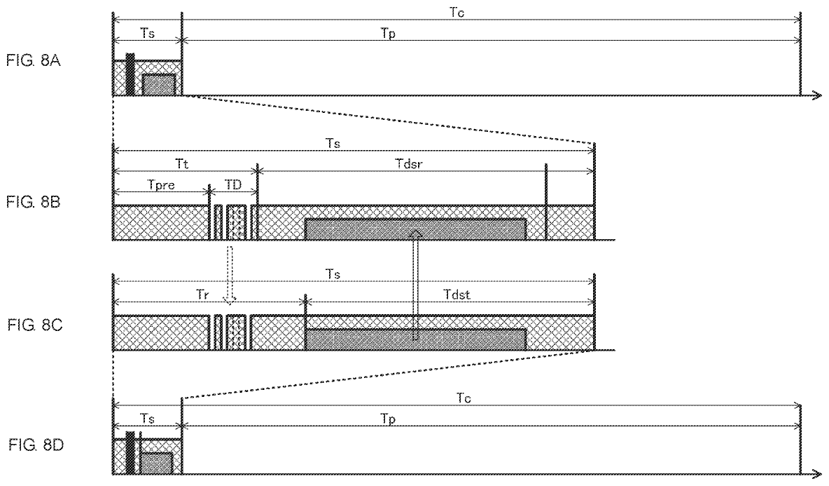

FIG. 8A is a diagram illustrating an example of the transmitting power voltage transition when the device code is not authenticated, and FIG. 8B is a diagram that expands a signal insertion period in FIG. 8A. FIG. 8D is a diagram illustrating an example of the received power voltage transition when the device code is not authenticated, and FIG. 8C is a diagram that expands a signal insertion period in FIG. 8D.

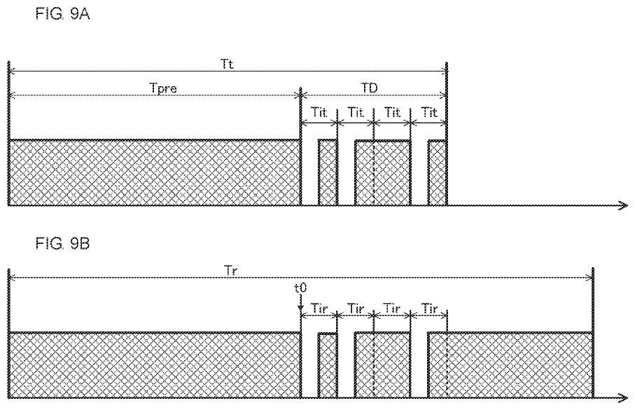

FIG. 9A is a diagram that expands an interrupt signal period in FIG. 8B, and FIG. 9B is a diagram that expands an interrupt signal period in FIG. 8C.

For example, as illustrated in FIG. 4, the power transmission device code is made up of 4 bits. The power transmission device code is formed from a start bit “1”, a two-bit device ID, and an end bit “1”.

Note that in the following section, an example is described for the case where the authentication is OK when the device ID is “11” and the authentication is NG when the device ID is “10”.

As illustrated in FIG. 5A, FIG. 5D, FIG. 8A, and FIG. 8D, the power transmission device 20 and the power reception device 30 set a repetition cycle Tc, and sending and receiving of signals between the transmission side and the reception side are repeated with this repetition cycle Tc.

As illustrated in FIG. 5A and FIG. 8A, the power transmission device 20 sets a signal insertion period Ts and a power exclusive-use period Tp in the repetition cycle Tc. Within the repetition cycle Tc, the power transmission device 20 sets the signal insertion period Ts and the power exclusive-use period Tp in this order from the start time of the repetition cycle Tc. The signal insertion period Ts is set at about 10% of the repetition cycle Tc or less.

As illustrated in FIG. 5B and FIG. 8B, the power transmission device 20 sets a power transmission side interrupt signal period Tt and a data receiving period Tdsr in the signal insertion period Ts. Within the signal insertion period Ts, the power transmission device 20 sets the power transmission side interrupt signal period Tt and the data receiving period Tdsr in this order from the start time of the signal insertion period Ts. The power transmission side interrupt signal period Tt is set at about 20% of the signal insertion period Ts.

The power transmission device 20 sets a preset power supply period Tpre and an actual insertion period TD in the power transmission side interrupt signal period Tt. Within the power transmission side interrupt signal period Tt, the power transmission device 20 sets the preset power supply period Tpre and the actual insertion period TD in this order from the start time of the power transmission side interrupt signal period Tt. The preset power supply period Tpre is set at about a time length within which a power that enables the realization of an authentication process can be supplied to the power reception device 30. The actual insertion period TD is set at a time length within which the power transmission device code (in the aforementioned case, 4-bit data) can be inserted.

As illustrated in FIG. 5D and FIG. 8D, the power reception device 30 sets a signal insertion period Ts and a power exclusive-use period Tp in the repetition cycle Tc. Within the repetition cycle Tc, the power reception device 30 sets the signal insertion period Ts and the power exclusive-use period Tp in this order from the start time of the repetition cycle Tc. The signal insertion period Ts is set at about 10% of the repetition cycle Tc or less. That is to say, in the power reception device 30 and the power transmission device 20, the signal insertion period Ts and the power exclusive-use period Tp are set with the same configuration and the same time length in the repetition cycle Tc.

The start time of the repetition cycle Tc of the power reception device 30 is synchronized with the start time of the repetition cycle Tc of the power transmission device 20. This synchronization can be achieved, for example, by detecting the time at which the power reception device 30 first receives power supply. Further, this synchronization can be achieved by using, as a reference, the detection time of an interrupt signal.

As illustrated in FIG. 5C and FIG. 8C, the power reception device 30 sets a power reception side interrupt signal period Tr and a data transmitting period Tdst in the signal insertion period Ts. Within the signal insertion period Ts, the power reception device 30 sets the power reception side interrupt signal period Tr and the data transmitting period Tdst in this order from the start time of the signal insertion period Ts.

The power reception side interrupt signal period Tr is set at about 40% of the signal insertion period Ts. That is to say, the power reception side interrupt signal period Tr is set longer than the power transmission side interrupt signal period Tt. Because of this, the power reception device 30 can receives the interrupt signal, which is the device code, more reliably.

In the state where the respective periods are set as described above, the power transmission device 20 controls the power transmission in such a way that power is continuously supplied to the power reception device 30 from the start of the repetition cycle Tc and during the signal insertion period Ts. More specifically, as illustrated in FIG. 7, the power transmission device 20 performs an interrupt signal control in such a way that a rectangular wave of a clock cycle TCL, which is based on the aforementioned clock frequency, is continuously output.

Moreover, the power transmission device 20 generates an interrupt signal based on the power transmission device code and performs an on-and-off control (switching control) of the switching circuit in the power transmission side interrupt signal period Tt of the signal insertion period Ts.

More specifically, during the preset power supply period Tpre, the MPU 212M of the power transmission device 20 does not perform the interrupt process using an interrupt signal and maintains a high potential for power supply. Because of this, power supply for authentication can be provided to the power reception device 30.

Further, during the actual insertion period TD, the MPU 212M of the power transmission device 20 generates an interrupt signal that has a low potential at a bit of “1” and a high potential at a bit of “0” (so as to maintain the high potential for power supply) in the power transmission device code and supplies a generated interrupt signal to the driver IC 212D. At this time, as illustrated in FIG. 6A and FIG. 7, the MPU 212M sets an individual bit period Tit that has a time length obtained by dividing the power transmission side interrupt signal period Tt by the number of bits of the device code. The MPU 212M assigns each bit of the device code to a corresponding individual bit period Tit.

Further, the MPU 212M generates a waveform for a bit of “1” by maintaining the low potential for a time length Tb that is shorter than the individual bit period Tit. That is to say, for a bit of “1”, during the individual bit period Tit, first, the period of the low potential is present for the time length Tb, and subsequently, the period of the high potential is present.

Note that as illustrated in FIG. 7, it is preferable that this time length Tb is set longer than the clock cycle TCL and is equal to or longer than two cycles of the clock cycle TCL. Because of this, since the time of the low potential in the time length Tb is present, it becomes possible to make a more reliable distinction between the waveform representing a bit of “1” and the rectangular wave of the clock cycle TCL.

On the other hand, as indicated at the third bit of FIG. 9B, the MPU 212M generates a waveform for a bit of “0” by maintaining the high potential for power supply for the duration of the individual bit period Tit.

Because of this, for example, in the case where the device code is “1111”, as illustrated in FIG. 5B, FIG. 6A, and FIG. 7, the waveform is such that a low potential period and a high potential period repeatedly appear alternately in this order four times from the start time of the actual insertion period TD.

On the other hand, in the case where the device code is “1101”, as illustrated in FIG. 8B and FIG. 9A, the waveform is such that the low potential period and the high potential period repeatedly appear alternately in this order three times from the start time of the actual insertion period TD, and the period between the second low potential period and the third low potential period is longer than the individual bit period Tit.

This enables the power transmission device 20 to transmit the power transmission device code to the power reception device 30 by utilizing the change in the amplitude of the transmitting power voltage.

The power reception device 30 detects the start time of the repetition cycle Tc by detecting a reception of power from the power transmission device 20. Further, the power reception device 30 continues to receive power supply from the power transmission device 20 from the start of the repetition cycle Tc and during the signal insertion period Ts.

In the power reception side interrupt signal period Tr of the signal insertion period Ts, the power reception device 30 first receives power supply and activates the MPU 314. More specifically, the power reception device 30 receives power supply for the duration of a period that corresponds to the preset power supply period Tpre of the power transmission device 20. This power activates the MPU 314.

In the power reception side interrupt signal period Tr of the signal insertion period Ts, the trigger generation circuit 315 of the power reception device 30 generates an interrupt detection signal by converting an alternating-current current of the received power into a voltage signal. The MPU 314 detects the change in the amplitude of the interrupt detection signal.

As illustrated in FIG. 6B and FIG. 9B, the MPU 314 detects the time at which the amplitude of the interrupt detection signal decreases for the first time and sets this time as a detection reference time t0 of the interrupt signal. Using the detection reference time t0 as a reference, the MPU 314 sets a plurality of individual bit periods Tir. The number of the plurality of individual bit periods Tir is set equal to the number of bits of the device code. The plurality of individual bit periods Tir are each set so as to have the same time length as the individual bit period Tit of the power transmission device 20.

The MPU 314 detects the change in the amplitude of the interrupt detection signal in each individual bit period Tir. The MPU 314 detects a bit of “1” when the individual bit period Tir including the low potential period is detected and detects a bit of “0” when the individual bit period Tir not including the low potential period is detected.

For example, as illustrated in FIG. 6B, when the low potential period is detected in each of four consecutive individual bit periods Tir from the detection reference time t0, the MPU 314 determines that a bit series of “1111” is detected. On the other hand, as illustrated in FIG. 9B, when the low potential period is detected in each of two consecutive individual bit periods Tir from the detection reference time t0, the low potential period is not detected in one individual bit period Tir, and the low potential period is detected in the next one individual bit period Tir, the MPU 314 determines that a bit series of “1101” is detected.

The MPU 314 demodulates the device ID from the detected bit series. For example, in the case of “1111”, the MPU 314 demodulates the device ID as “11” by deleting the start bit “1” and the end bit “1”. Further, in the case of “1101”, the MPU 314 demodulates the device ID as “10” by deleting the start bit “1” and the end bit “1”.

Because of the process described above, the MPU 314 of the power reception device 30 can identifies the device ID of the power transmission device 20 by utilizing the amplitude of the received power voltage.

The MPU 314 authenticates the power transmission device 20 by using the identified device ID. More specifically, the MPU 314 stores device IDs with authentication OK in memory or the like in advance. The MPU 314 determines that the identified device ID is successfully authenticated (OK) if the identified device ID is one of the device IDs with authentication OK. On the other hand, the MPU 314 determines that the identified device ID is not authenticated (NG) if the identified device ID is not one of the device IDs with authentication OK.

As described above, in the wireless power transfer system 1, the power reception device 30 can authenticate the power transmission device 20. In this case, the wireless power transfer system 1 performs the authentication by using the amplitude of voltage of the power being transmitted and received, and thus it is not necessary to include another circuit configuration for authentication in addition to the circuit configuration for power transmission and reception. Because of this, the wireless power transfer system 1 can realize a secure system with a simple configuration.

Further, in the configuration and the process described above, the signal insertion period Ts to be used for authentication is 10% of the repetition cycle Tc or less, and the power exclusive-use period Tp, which is the period where the interruption for authentication is not performed, is 90% of the repetition cycle Tc or more. Because of this, while mainly providing power supply, the wireless power transfer system 1 also performs the interrupt process for authentication in a localized period. Accordingly, the wireless power transfer system 1 can suppress the decrease in the power reception efficiency caused by performing authentication. That is to say, the wireless power transfer system 1 can realize a secure system with a high degree of the power reception efficiency.

Moreover, also in the signal insertion period Ts, the high potential for power supply is maintained except some low potential periods of the individual bit periods Tit and Tir, each of which represents the bit “1”. Because of this, the wireless power transfer system 1 can further suppress the decrease in the power reception efficiency caused by performing the authentication.

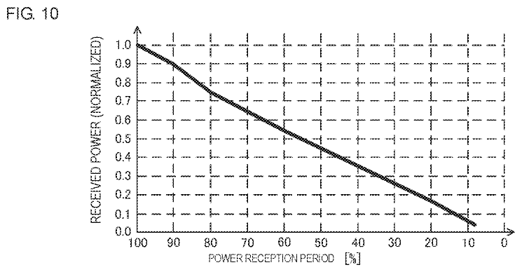

FIG. 10 is a graph illustrating an example of the relationship between the length of power reception period and the received power. In FIG. 10, the horizontal axis represents the ratio of the power reception period (power exclusive-use period Tp) to the repetition cycle, and the vertical axis represents the normalized value of the received power. The vertical axis indicates the value that becomes equal to 1 when the power reception period is 100%.

As illustrated in FIG. 10, the received power decreases as the power reception period (power exclusive-use period Tp) becomes shorter. In other words, the received power increases as the power reception period (power exclusive-use period Tp) becomes longer. Further, by setting the power reception period (power exclusive-use period Tp) at 90% or more, it becomes possible to have a received power of 0.9 or more when the power reception period (power exclusive-use period Tp) during which no authentication is performed is 100%. Accordingly, by setting the power reception period (power exclusive-use period Tp) at 90% or more, the decrease in the received power can be suppressed to a level of an installation error of the power reception coil 39 relative to the power transmission coil 29, and this enables the realization of a system having a better power reception efficiency.

Note that the power reception period can be set at less than 90%. However, by setting the power reception period at least at 70% or more, the decrease in the power reception efficiency can be suppressed to a practical level.

Note that the power reception device 30 and the power transmission device 20 perform the following processes based on the result of authentication in the MPU 314.

### (A) Control of Power Supply to Load Circuit 99 in Power Reception Device 30

If the authentication is OK, the MPU 314 supplies power to the load circuit 99 by controlling the voltage control circuit 317. On the other hand, if the authentication is NG, the MPU 314 terminates power supply to the load circuit 99 by controlling the voltage control circuit 317.

### (B) Returning of Authentication Result to Power Transmission Device 20 and Power Transmission Operation in Power Transmission Device 20

The MPU 314 generates an authentication code based on the result of authentication. The MPU 314 supplies the authentication code to the modulation control circuit 316.

The modulation control circuit 316 adjusts the impedance of the resonance adjustment circuit 311 based on the authentication code.

As is the case with the authentication of the power reception device 30 described above, a change in the impedance of the resonance adjustment circuit 311 changes the coupling state between the power reception coil 39 and the power transmission coil 29, and this changes the level of load modulation.

In the power transmission device 20, when the level of load modulation changes, the current value of the direct-current current that flows through the power transmission circuit 21 changes. Because of this, the authentication code from the power reception device 30 is transmitted from the power reception device 30 to the power transmission device 20 by using the alternating-current signal for power transmission and reception.

The detector 216 voltage-converts this direct-current current, generates an authentication code detection signal, and outputs this authentication code detection signal to the MPU 212M.

The MPU 212M demodulates the authentication code from the authentication code detection signal and determines whether the authentication code is authentication OK or authentication NG. When the MPU 212M determines that the authentication code is the authentication OK, the MPU 212M continues the power transmission operation. Because of this, as illustrated in FIG. 5A and FIG. 5D, power is continuously supplied from the power transmission device 20 to the power reception device 30 during the power exclusive-use period Tp. On the other hand, if the MPU 212M determines that the authentication code is the authentication NG, the MPU 212M terminates the power transmission. Because of this, as illustrated in FIG. 8A and FIG. 8D, during the power exclusive-use period Tp, power is not supplied from the power transmission device 20 to the power reception device 30.

This enables the power transmission device 20 to realize power transmission to a power reception device 30 to which power needs to be transmitted and ensures the prevention of power transmission to a power reception device 30 to which power should not be transmitted. Further, as a result, the power reception device 30 can receive power from a power transmission device 20 from which power should be received and can prevent power reception from a power transmission device 20 from which power should not be received.

As illustrated in FIG. 5C, FIG. 5B, FIG. 8C, and FIG. 8B, the above-described transmission process of the authentication code from the power reception device 30 to the power transmission device 20 is performed in the data transmitting period Tdst of the signal insertion period Ts and the data receiving period Tdsr of the signal insertion period Ts. That is to say, the transmission process of the authentication code is also performed during a time period that is different from the power exclusive-use period Tp. As described above, the signal insertion period Ts is considerably shorter than the power exclusive-use period Tp, and during a power transmission-and-reception period, the power exclusive-use period is set as a main period, and the signal insertion period during which the interrupt signal is inserted is set as a localized period. Thus, the wireless power transfer system 1 can suppress the decrease in the power reception efficiency caused by transmitting and receiving of the authentication code. Moreover, the period during which the authentication code is actually being transmitted and received is part of the signal insertion period Ts. Accordingly, the wireless power transfer system 1 can further suppress the decrease in the power reception efficiency caused by transmitting and receiving of the authentication code.

### Description of Various Modes of Authentication

In the aforementioned description, the authentication of the power transmission device 20 and the authentication of the power reception device 30 are described using specific configurations of the power transmission device 20 and the power reception device 30. In the following section, for a better understanding of the flow of control, the authentication of the power transmission device 20 and the authentication of the power reception device 30 are described using flowcharts.

### First Mode

The first mode is a mode in which the power reception device 30 authenticates the power transmission device 20 and returns the result of authentication to the power transmission device 20.

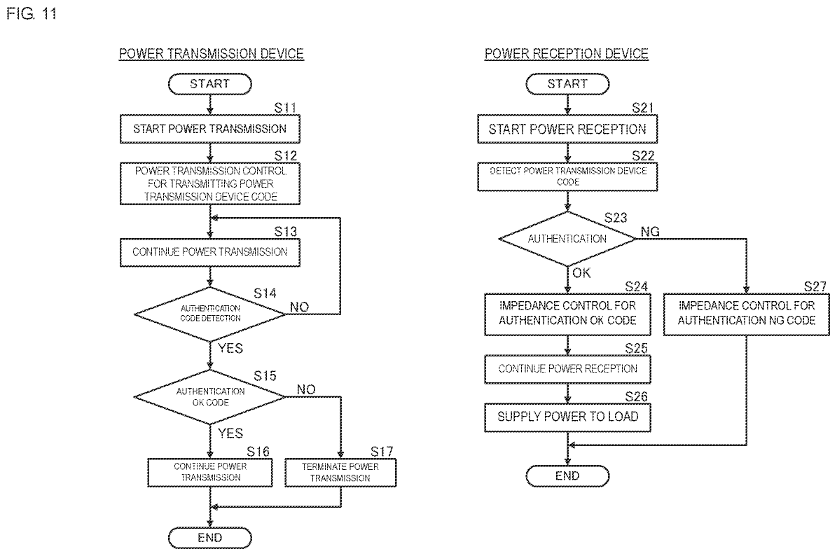

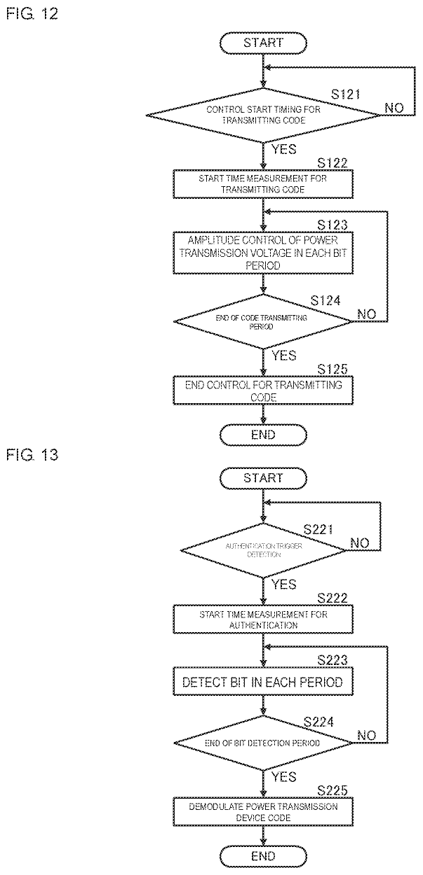

FIG. 11 includes flowcharts illustrating the first mode of authentication. FIG. 12 is a flowchart of power transmission control for transmitting the power transmission device code illustrated in FIG. 11. FIG. 13 is a flowchart of detection of a power transmission device code illustrated in FIG. 11.

As illustrated in FIG. 11, once the power transmission device 20 starts power transmission (S11), the power transmission device 20 performs a power transmission operation for transmitting the power transmission device code (S12).

In the power transmission operation for transmitting the power transmission device code, the power transmission device 20 continues power transmission only for power supply until a control start timing for transmitting the code (start timing of the actual insertion period TD) is reached (S121: NO). At the control start timing for transmitting the code (S121: YES), the power transmission device 20 starts a time measurement for transmitting the code (S122).

The power transmission device 20 looks up the measured time and performs an amplitude control of the transmitting power voltage in each individual bit period Tit so as to realize the power transmission device code (S123). The power transmission device 20 repeats this amplitude control until a code transmitting period (actual insertion period TD) ends (S124: NO). If the code transmitting period (actual insertion period TD) ends (S124: YES), the power transmission device 20 ends the power transmission operation for transmitting the power transmission device code (S125). Further, the power transmission device 20 continues the power transmission operation that performs only power transmission (S13). Note that the continuation of power transmission operation performed in this step S13 is limited within the signal insertion period Ts (see FIG. 8A), and the operations in steps S12 and S13 are repeated until an authentication code, which will be described later, is obtained.

Once the power reception device 30 starts power reception (S21), the power reception device 30 detects the power transmission device code (S22).

In the detection of the power transmission device code, the power reception device 30 continues the detection of an authentication trigger (an event in which the amplitude of the aforementioned interrupt detection signal decreases for the first time) until the authentication trigger is detected (S221: NO), and if the authentication trigger is detected (S221: YES), the power reception device 30 starts a time measurement for authentication (S222).

The power reception device 30 looks up the measured time and detects a bit by detecting a change in the amplitude of the interrupt detection signal based on the received power voltage in each individual bit period Tir (S223). The power reception device 30 repeats this bit detection until a bit detection period ends (S224: NO). For example, the bit detection period is set at a time length that is obtained by multiplying the number of bits of the power transmission device code stored in advance by the individual bit period Tir.

When the bit detection period ends (S224: YES), the power reception device 30 demodulates the power transmission device code (S225).

The power reception device 30 authenticates the power transmission device 20 by using the power transmission device code. If the authentication of the power transmission device 20 is OK (S23: OK), the power reception device 30 performs an impedance control for authentication OK code (S24). Further, the power reception device 30 continues power reception (S25) and supplies power to the load circuit 99 (S26).

If the authentication of the power transmission device 20 is NG (S23: NG), the power reception device 30 performs an impedance control for authentication NG code (S27).

The power transmission device 20 detects the authentication code (S14) by detecting a change of a transmitting current that changes in response to the impedance control of the power reception device 30. Note that the power transmission device 20 continues the power transmission (S13) until the authentication code is detected (S14: NO).

If the authentication code is the authentication OK code (S15: YES), the power transmission device 20 continues the power transmission (S16). If the authentication code is the authentication NG code (S15: NO), the power transmission device 20 terminates the power transmission (S17).

### Second Mode

The second mode is a mode in which the power reception device 30 authenticates the power transmission device 20 and does not return the result of authentication to the power transmission device 20. Note that the power transmission control for transmitting the power transmission device code in the power transmission device 20 and the detection of the power transmission device code in the power reception device 30 are the same as those of the first mode, and the descriptions thereof are omitted.

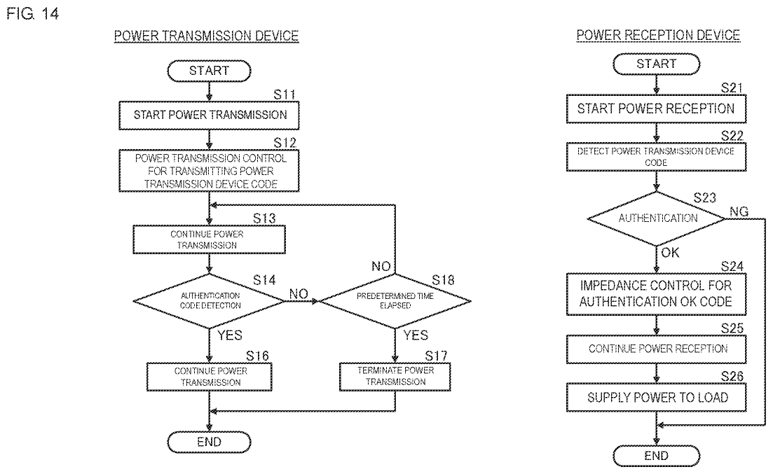

FIG. 14 includes flowcharts illustrating the second mode of authentication.

As illustrated in FIG. 14, once the power transmission device 20 starts power transmission (S11), the power transmission device 20 performs a power transmission operation for transmitting the power transmission device code (S12). Further, the power transmission device 20 continues the power transmission operation that performs only the power transmission (S13).

Once the power reception device 30 starts power reception (S21), the power reception device 30 detects the power transmission device code (S22).

The power reception device 30 authenticates the power transmission device 20 by using the power transmission device code. If the authentication of the power transmission device 20 is OK (S23: OK), the power reception device 30 performs an impedance control for authentication OK code (S24). Further, the power reception device 30 continues power reception (S25) and supplies power to the load circuit 99 (S26).

The power transmission device 20 detects the authentication code (S14) by detecting a change of the transmitting current that changes in response to the impedance control of the power reception device 30. Note that the power transmission device 20 continues the power transmission (S13) if the authentication code is not detected (S14: NO) and a predetermined time is not elapsed (S18: NO).

If the authentication code (authentication OK code) is detected (S14: YES), the power transmission device 20 continues the power transmission (S16).

If the authentication code is not detected (S14: NO) and the predetermined time is elapsed (S18: YES), the power transmission device 20 terminates the power transmission (S17).

### Third Mode

The third mode is a mode in which the power reception device 30 and the power transmission device 20 authenticate each other. In the third mode, after performing the authentication of the power reception device 30 by the power transmission device 20, the power transmission device 20 is authenticated by the power reception device 30. Note that the third mode is different from the first mode in adding the authentication of the power reception device, and the third mode and the first mode are the same in subsequent processes. Accordingly, the descriptions regarding the same parts are omitted.

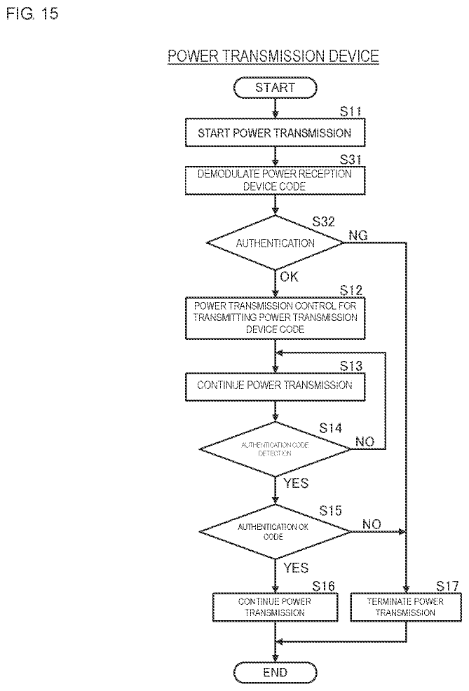

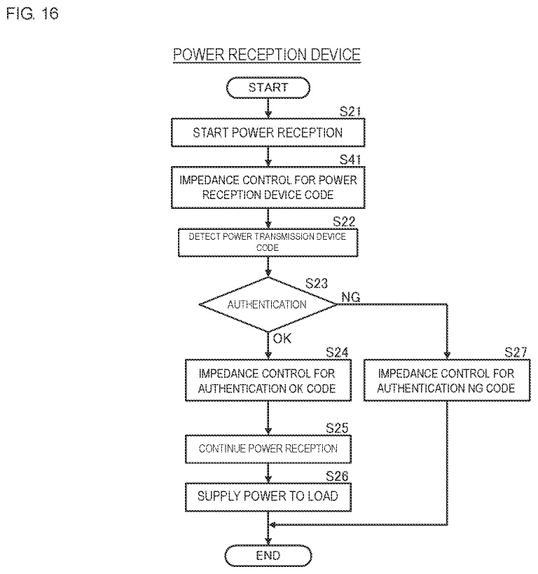

FIG. 15 is a flowchart of processes in the power transmission device according to the third mode of authentication. FIG. 16 is a flowchart of processes in the power reception device according to the third mode of authentication.

As illustrated in FIG. 16, once the power reception device 30 starts power reception (S21), the power reception device 30 performs an impedance control for power reception device code (S41). That is to say, the power reception device 30 performs an impedance control of the power reception resonant circuit by using the power reception device code.

As illustrated in FIG. 15, the power transmission device 20 demodulates the power reception device code (S31) by detecting the change in the amplitude of a transmitting power current. The power transmission device 20 authenticates the power reception device 30 by using the power reception device code.

If the authentication of the power reception device 30 is OK (S32: OK), as is the case with the first mode described above, the power transmission device 20 performs a process for authentication of the power transmission device 20.

If the authentication of the power reception device 30 is NG (S32: NG), the power transmission device 20 terminates the power transmission (S17).

### Fourth Mode

The fourth mode is a mode in which the power reception device 30 and the power transmission device 20 authenticate each other. In the fourth mode, after performing the authentication of the power transmission device 20 by the power reception device 30, the power reception device 30 is authenticated by the power transmission device 20. Note that as is the case with the third mode, the fourth mode is different from the first mode in adding the authentication of the power reception device, and the fourth mode and the first mode are the same in subsequent processes. Accordingly, the descriptions regarding the same parts are omitted.

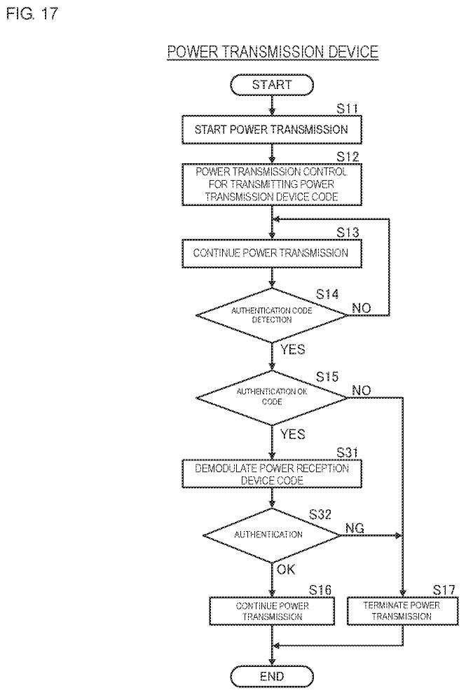

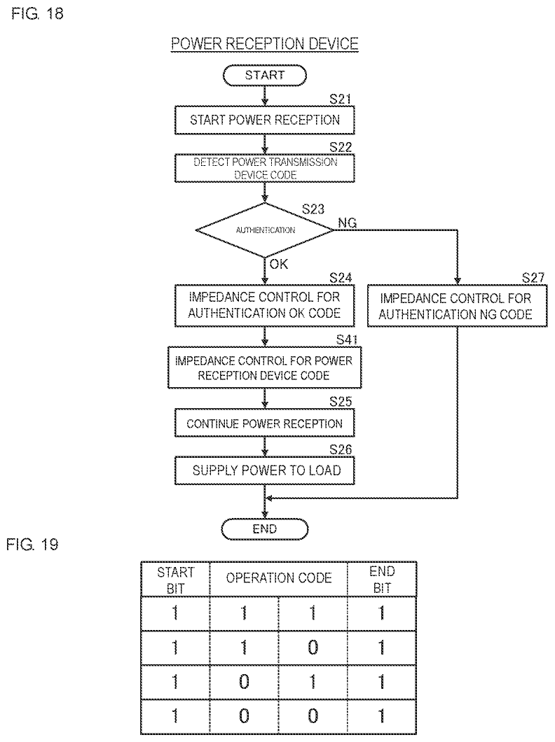

FIG. 17 is a flowchart of processes in the power transmission device according to the fourth mode of authentication. FIG. 18 is a flowchart of processes in the power reception device according to the fourth mode of authentication.

As illustrated in FIG. 18, if the authentication of the power transmission device 20 is OK (S23: OK), the power reception device 30 performs an impedance control for authentication OK code (S24) and performs an impedance control for power reception device code (S41).

As illustrated in FIG. 17, if the power transmission device 20 detects the authentication OK code issued for itself from the power reception device 30 by detecting the change in the amplitude of the transmitting power current (S15: YES), the power transmission device 20 demodulates the power reception device code (S31). The power transmission device 20 authenticates the power reception device 30 by using the power reception device code.

If the authentication of the power reception device 30 is OK (S32: OK), the power transmission device 20 continues the power transmission (S16). If the authentication of the power reception device 30 is NG (S32: NG), the power transmission device 20 terminates the power transmission (S17).

### Mode of Transmitting and Receiving Operation Code

In the aforementioned description, the modes are described in each of which the device code or the authentication code is transmitted using the amplitude change of voltage for transmitting power. However, an operation code can also be transmitted using the amplitude change of voltage for transmitting power. The operation code is a code that defines an operation command signal for operation transition of the power reception device 30.

FIG. 19 is a diagram illustrating examples of the operation code. As illustrated in FIG. 19, the operation code is made up of 4 bits. The operation code is formed from a start bit “1”, a two-bit operation ID, and an end bit “1”.

The operation ID is associated with operation performed by the power reception device 30 (power supply control and the like) and is stored in the power transmission device 20 and the power reception device 30.

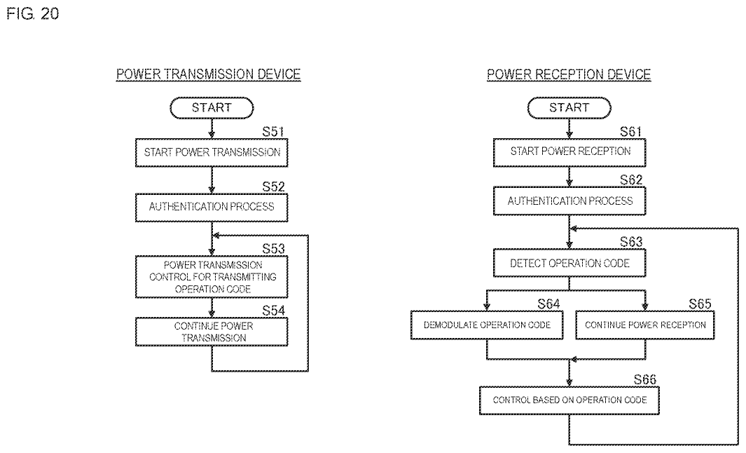

FIG. 20 includes flowcharts for operation control.

As illustrated in FIG. 20, once the power transmission device 20 starts power transmission (S51), the power transmission device 20 performs an authentication process according to one of the modes described above (S52).

Further, if the authentication is OK, the power transmission device 20 performs a power transmission operation for transmitting an operation code (S53) and continues power transmission (S54). Note that the power transmission operation for transmitting the operation code is a control in which the power transmission device code in the aforementioned power transmission operation for transmitting the power transmission device code is replaced with the operation code.

The power transmission device 20 repeats the power transmission operation for transmitting the operation code every time an operation control of the power reception device 30 is performed.

Once the power reception device 30 starts power reception (S61), the power reception device 30 performs an authentication process according to one of the modes described above (S62).

The power reception device 30 detects the operation code (S63), demodulates the operation code (S64), and continues power reception (S65). Note that the detection and demodulation of the operation code are the same processes as the detection and demodulation of the power transmission device code described above.

The power reception device 30 generates an operation command signal for operation transition based on the operation code and carries out a control that uses the operation command signal (S66). Because of this, the operation of the power reception device 30 transitions. Every time the operation code from the power transmission device 20 is detected and demodulated, the power reception device 30 carries out a control that corresponds to this demodulated operation code.

As described above, with the wireless power transfer system 1, in addition to the authentication, the operation control can also be realized using the voltage for transmitting power. Further, as is the case with the authentication, the transmitting of the operation code is also performed during the signal insertion period Ts which is different from the power exclusive-use period Tp. Accordingly, the wireless power transfer system 1 can suppress the decrease in the power reception efficiency while wirelessly controlling the operation of the power reception device 30.

Note that in the description described above, the modes are illustrated in which the voltage control circuit 317 is used for power supply to the load circuit 99 in the power reception device 30. However, the power supply to the load circuit 99 may alternatively be performed by a regulator circuit.

What is claimed is:

1. A wireless power transfer system comprising:
a power transmission device including a power transmission circuit and a power transmission coil, the power transmission circuit being configured to generate, from a direct-current voltage, both alternating-current power for power transmission and a power transmission signal, the power transmission coil being configured to wirelessly transmit the alternating-current power and wirelessly transmit the power transmission signal; and
a power reception device including a power reception coil and a power reception circuit, the power reception coil being configured to electromagnetically couple with the power transmission coil, the power reception circuit being configured to convert alternating-current power received with the power reception coil into a direct-current voltage by rectifying the alternating-current power, wherein
the power transmission circuit includes
a power transmission side control circuit configured to generate an interrupt signal for power transmission authentication, and
a power transmission side switching circuit configured to adjust output of the power transmission signal to the power transmission coil by using the interrupt signal,
the power reception circuit includes
a power reception side control circuit configured to determine, from the power transmission signal, the interrupt signal for power transmission authentication corresponding to the power transmission device, authenticate power transmission of the power transmission device by using the interrupt signal for power transmission authentication, and after performing the power transmission authentication, start power supply to a load circuit or charging of a rechargeable battery, and
the power transmission side control circuit and the power reception side control circuit each being configured to set a power exclusive-use period and a signal insertion period, the power exclusive-use period being set as a main part of a power transmission-and-reception period during which the interrupt signal for power transmission authentication is not used, and the signal insertion period being set as a localized part of the power transmission-and-reception period during which the interrupt signal for power transmission authentication is inserted.

2. The wireless power transfer system according to claim 1, wherein
a period of 90% or more of the power transmission-and-reception period is assigned to the power exclusive-use period, and
a remaining period of the power transmission-and-reception period other than the power exclusive-use period is assigned to the signal insertion period.

3. The wireless power transfer system according to claim 1, wherein
the signal insertion period of the interrupt signal for power transmission authentication is set in advance in the power transmission side control circuit and the power reception side control circuit, and
the power reception side control circuit is configured to
detect a start of the signal insertion period, and
perform the power transmission authentication by using amplitude information of a power reception signal at predetermined time intervals with time of the start of the signal insertion period as a reference.

4. The wireless power transfer system according to claim 1, wherein
the power reception side control circuit is configured to control, for power reception authentication of the power reception device, a change of an impedance determined by the power reception coil and the power reception circuit, and
the power transmission side control circuit is configured to
perform the power reception authentication of the power reception device from a change of a current in the power transmission circuit caused by the change of the impedance on the power reception device side, and
generate the interrupt signal for power transmission authentication after performing the power reception authentication of the power reception device.

5. The wireless power transfer system according to claim 1, wherein
the power transmission side control circuit is configured to control, for the power transmission authentication of the power transmission device, a change of a switching operation determined by the power transmission coil and the power transmission circuit, and
the power reception side control circuit is configured to
perform the power transmission authentication of the power transmission device by using a change of a current in the power reception circuit caused by the change of the switching operation on the power transmission device side, and
generate a change of impedance for power reception authentication after performing the power transmission authentication of the power transmission device.

6. The wireless power transfer system according to claim 1, wherein
the power transmission side control circuit is configured to generate, during the signal insertion period, an operation command signal for operation transition on a power reception side, and
the power reception side control circuit is configured to transition, upon detection of the operation command signal, operation of the power reception device.

7. The wireless power transfer system according to claim 6, wherein
the power transmission side control circuit is configured to
set a plurality of signal insertion periods for the operation command signal with time intervals in between, and
generate the operation command signal for each of the plurality of signal insertion periods, and
the power reception side control circuit is configured to transition the operation of the power reception device every time the operation command signal is detected.

8. The wireless power transfer system according to claim 1, wherein
the power reception circuit includes a power reception side regulator circuit or a voltage conversion circuit configured to provide power supply to the load circuit or the rechargeable battery, and
the power reception side control circuit is configured to perform, depending on a result of power reception authentication, an output control of an enable signal for the voltage conversion circuit or a control of the power reception side regulator circuit.

9. The wireless power transfer system according to claim 1, wherein
the load circuit includes a sensing circuit or a wireless communication circuit.

10. The wireless power transfer system according to claim 2, wherein
the signal insertion period of the interrupt signal for power transmission authentication is set in advance in the power transmission side control circuit and the power reception side control circuit, and
the power reception side control circuit is configured to
detect a start of the signal insertion period, and
perform the power transmission authentication by using amplitude information of a power reception signal at predetermined time intervals with time of the start of the signal insertion period as a reference.

11. The wireless power transfer system according to claim 2, wherein
the power reception side control circuit is configured to control, for power reception authentication of the power reception device, a change of an impedance determined by the power reception coil and the power reception circuit, and
the power transmission side control circuit is configured to
perform the power reception authentication of the power reception device from a change of a current in the power transmission circuit caused by the change of the impedance on the power reception device side, and
generate the interrupt signal for power transmission authentication after performing the power reception authentication of the power reception device.

12. The wireless power transfer system according to claim 3, wherein
the power reception side control circuit is configured to control, for power reception authentication of the power reception device, a change of an impedance determined by the power reception coil and the power reception circuit, and
the power transmission side control circuit is configured to
perform the power reception authentication of the power reception device from a change of a current in the power transmission circuit caused by the change of the impedance on the power reception device side, and
generate the interrupt signal for power transmission authentication after performing the power reception authentication of the power reception device.

13. The wireless power transfer system according to claim 2, wherein
the power transmission side control circuit is configured to control, for the power transmission authentication of the power transmission device, a change of a switching operation determined by the power transmission coil and the power transmission circuit, and
the power reception side control circuit is configured to
perform the power transmission authentication of the power transmission device by using a change of a current in the power reception circuit caused by the change of the switching operation on the power transmission device side, and
generate a change of impedance for power reception authentication after performing the power transmission authentication of the power transmission device.

14. The wireless power transfer system according to claim 2, wherein
the power transmission side control circuit is configured to generate, during the signal insertion period, an operation command signal for operation transition on a power reception side, and
the power reception side control circuit is configured to transition, upon detection of the operation command signal, operation of the power reception device.

15. The wireless power transfer system according to claim 2, wherein
the power reception circuit includes a power reception side regulator circuit or a voltage conversion circuit configured to provide power supply to the load circuit or the rechargeable battery, and
the power reception side control circuit is configured to perform, depending on a result of power reception authentication, an output control of an enable signal for the voltage conversion circuit or a control of the power reception side regulator circuit.

16. The wireless power transfer system according to claim 2, wherein
the load circuit includes a sensing circuit or a wireless communication circuit.

17. A power transmission device of a wireless power transfer system, the power transmission device comprising:
a power transmission circuit configured to generate, from a direct-current voltage, both alternating-current power for power transmission and a power transmission signal; and
a power transmission coil configured to wirelessly transmit the alternating-current power, wherein
the power transmission circuit includes
a power transmission side control circuit configured to generate an interrupt signal for power transmission authentication, and
a power transmission side switching circuit configured to adjust output of the power transmission signal to the power transmission coil by using the interrupt signal, and
the power transmission side control circuit is configured to set a power exclusive-use period and a signal insertion period, the power exclusive-use period being set as a main part of a power transmission-and-reception period during which the interrupt signal for power transmission authentication is not used, and the signal insertion period being set as a localized part of the power transmission-and-reception period during which the interrupt signal for power transmission authentication is inserted.

18. The power transmission device of a wireless power transfer system according to claim 17, wherein
the power transmission side control circuit is configured to output the interrupt signal for power transmission authentication after performing power reception authentication of a power reception device including a power reception coil that electromagnetically couples with the power transmission coil.

19. A power reception device of a wireless power transfer system, the power reception device comprising:
a power reception coil configured to electromagnetically couples with a power transmission coil of a power transmission device; and
a power reception circuit configured to convert alternating-current power received with the power reception coil into a direct-current voltage by rectifying the alternating-current power, wherein
the power reception circuit includes a power reception side control circuit configured to determine, from a power transmission signal, an interrupt signal for power transmission authentication corresponding to the power transmission device, authenticate power transmission of the power transmission device by using the interrupt signal for power transmission authentication, and after performing the power transmission authentication, start power supply to a load circuit or charging of a rechargeable battery.

20. The power reception device of a wireless power transfer system according to claim 19, wherein
a signal insertion period for the interrupt signal for power transmission authentication in a power transmission-and-reception period is set in advance, and
the power reception side control circuit is configured to
detect a start of the signal insertion period, and
perform the power transmission authentication by using amplitude information of a power reception signal at predetermined time intervals with time of the start of the signal insertion period as a reference.
